(19) United States
(12) Patent Application Publication
(10) Pub. No.: US 2005/0125244 A1
(43) Pub. Date: Jun. 9, 2005

(54) System for hot machine notification

(76) Inventor: Richard J. Schneider, Las Vegas, NV (US)

Correspondence Address: MARGER JOHNSON & McCOLLOM, P.C., 1030 S.W. Morrison Street, Portland, OR, 97205, US

(21) Appl. No.: 10/731,175

(22) Filed: Dec. 8, 2003

(51) Int. Cl. G06F 17/60

(52) U.S. Cl. 705/1

(57) ABSTRACT

The system allows a player to identify those gaming machines the player believes are more likely to hit a jackpot using an individual gaming machine's historical data. A gaming machine's historical payout data can be communicated to a player by monitoring payout events, storing records of the payout events, and communicating the payout events to the player in a format chosen by the player.

### TECHNICAL FIELD

This disclosure relates to networked gaming devices or machines, and, more specifically, to a system for communicating to a player the identity and location of “hot” machines to allow the player to identify those machines he/she believes are more likely to hit jackpots.

### BACKGROUND

Gaming machines and gaming machine establishments like casinos are popular entertainment attracting a loyal following in addition to casual players. Many visitors, or players, who frequent casinos are superstitious and have preferences as to the individual games they are likely to play while visiting a given casino. Although gaming machines pay out on a random basis that cannot be deduced by the player, many players believe that certain criteria can be taken into consideration to increase the player's opportunity to hit a jackpot or otherwise experience a win.

For example, some players might believe that a machine that has not experienced a jackpot in a long while, a cold machine, is due for a win. Others might believe that a machine that has experienced a recent jackpot is a hot machine and is likely to hit for another win. Such preferences differ by player and different players take different criteria into account.

At present there is no system in place to provide information to players about whether a machine is hot or cold, when the machine last hit, or how many times a given machine has hit relative to other machines. Such information is desirable to those players having a particular set of criteria in mind for their play. Although some roulette wheels keep records of the last 10 to 30 numbers to win, historical payout data has not been made available to players of gaming machines.

The only information currently available to a player is based on what will happen statistically. For example, banks of machines advertise payout percentages or apply a certain percentage of coins wagered to a pool that will pay out when a magic number is reached. Unlike hot or cold machine information, this type of information is based on what will happen to a group of machines over time, rather than appealing to the player's perception about what might happen on a given machine.

Embodiments of the invention address these and other deficiencies in casino gaming systems.

### BRIEF DESCRIPTION OF THE DRAWINGS

The description may be best understood by reading the disclosure with reference to the accompanying drawings.

FIG. 1 is a block diagram showing a gaming device used for embodiments of the invention.

FIGS. 2A and 2B together are a block diagram showing components of a gaming network according to embodiments of the invention.

FIG. 3 is an example flow diagram showing example processes that can be performed by the network of FIGS. 2A and 2B.

FIG. 4 is an example flow diagram showing additional example processes that can be performed by the network of FIGS. 2A and 2B., including allowing the player to generate his/her own reports.

FIG. 5 is a block diagram showing sample input criteria for generating a standard report.

FIG. 6 is a block diagram showing a sample custom report for a specific gaming device.

### DETAILED DESCRIPTION

Embodiments of the invention include a method of communicating a gaming machine's past payouts to a player in various ways. As used in this description, payouts or payout data can refer, for example, to the actual amounts of money or other bonus paid out by a particular machine, dates on which the machine paid out, the amount a given machine has paid out relative to other machines, the amount a given machine has paid out in a given time relative to the typical payout of the machine, the frequency with which a machine has paid out relative to other machines, the number of times an amount was paid out in a specified time period, the elapsed time since an amount has been paid out, particular events or hand types causing a payout to be made such as four-of-a-kind, the date and amount of jackpots or large awards, and the total amount of amounts paid out as a percentage of the amount taken in by the casino. As used in this description, a pay table of a gaming device is the standard winnings paid or credited to the player by the device itself.

Providing information about past payouts to individual or groups of players is advantageous to players with criteria in mind for their play. Providing any information that increases the likelihood that a given player will play at a particular casino is advantageous to the casino.

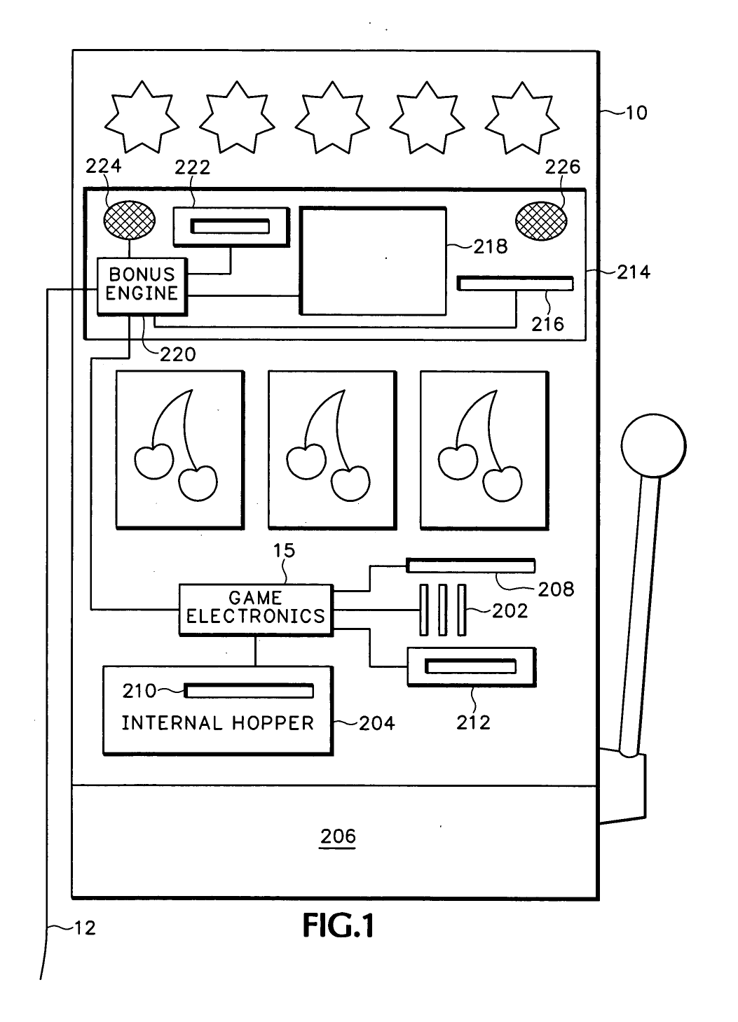

Turning to FIG. 1, an electronic gaming device (“EGM”) 10 according to an embodiment of the invention is shown. The EGM 10 includes a bill acceptor 208 that accepts and validates bills, tickets or vouchers. Bill validators operate by scanning barcodes or other identifying features on tickets or vouchers, and by examining printing or other security features on paper currency to determine authenticity. Bill validators are well known in the gaming arts.

The EGM 10 also includes one or more coin slots 202 for accepting coins or tokens. An internal hopper 204 temporarily stores coins or tokens for later payment to the player through a payout bin 206, if the player chooses to cash out in such a manner. Bills can also be stored in a separate hopper, and dispensed to the player through the bill acceptor 208 or through another bill slot 210 in the machine cabinet, similar to an ATM machine.

A set of game electronics 15 manages the central operations of the gaming device 10. For example, the game electronics 15 counts the monetary value input into the EGM 10, and tracks and stores values for this and other data items. The game electronics 15 also control the game play of the EGM 10, such as by accepting user input from various buttons (not shown) to cause credits to be wagered, as well as cause motors to spin the game wheels, speakers to generate sound, and circuits to generate lights or video signals. The game electronics 15 may be a main board that interfaces with various controller boards that control specific functions in the EGM 10, or may control the various devices directly.

One of the items controlled by the game electronics 15 is an internal game printer 212. The game printer 212 can be of any type known in the art, such as impact, inkjet, thermal, laser, and can be a color printer or standard black and white. Even if the game printer 212 is only capable of printing in a single color, cardstock or paper used by the printer could be pre-printed in color.

The EGM 10 also includes game-mounted components of a player tracking system. The components are generally shown affixed to a frame 214, which is mounted to the gaming device 10. Although components of the tracking system interact with the EGM 10, it is a separate system from the gaming device.

The player tracking system includes a set of electronic inputs and outputs for interfacing with the player. For example, in the gaming device shown in FIG. 1, portions of the player tracking system mounted to the frame 214 include a cardslot with a card reader 216 and a touchscreen display 218. Alternate embodiments could use a traditional keypad, not shown. The display screen 218 may be a Liquid Crystal Display (LCD), for example. A detailed description of such a touchscreen display 218 is described in U.S. patent application Ser. No. 10/170,238, filed on Jun. 11, 2002, and is incorporated herein by reference for all purposes. As described in the 10/170,238 application, the bonus engine 220 manages the touchscreen display 218, and card reader 216, as well as provides the bonusing and other functions described above. A player of the gaming device 10 uses a card and/or a PIN code to identify himself or herself to the player tracking system. Monetary value can be entered into the game, either from the ID card itself, from a credit-card account with a bank or from a special gaming account managed by a casino. Alternatively, a player can use the card and/or PIN code to identify himself or herself, and then put credits on the machine by depositing coins, tokens, bills, or tickets/vouchers into the machine.

The card reader 216 and display 218 are managed by functions operating on a “bonus engine” 220, which is a specialized piece of hardware used in the player tracking network. The bonus engine 220 is coupled by a computer connection to the gaming network, and plays a central role in the player tracking system. The bonus engine 220 is in constant communication between the game electronics 15 and the gaming network. The bonus engine 220 receives constant status updates about the state and status of the EGM 10. The game electronics 15 may automatically send information to the bonus engine 220, such as “events”, when the events occur, such as at the end of the game, or when a key event happens like a bill being accepted into the EGM 10. Or, the bonus engine 220 may send electronic updates, requests, or polls to the game electronics 15. When polled, the game electronics 15 sends the latest events to the bonus engine 220. Additionally, the gaming network can send commands and directives to a particular EGM 10 through the bonus engine 220 of that device. The bonus engine 220 then performs the commands, such as by displaying a message on the display 218, or the bonus engine delivers the commands to the game electronics 15 of that gaming device.

The EGM 10 further includes a system printer 222 and speakers 224 mounted to the frame 214 of the player tracking system. The system printer 222 and speakers 226 are also coupled to and managed by the bonus engine 220. The system printer 222 works in conjunction with the game printer 212 in that the system printer 222 prints the awards while the game printer 212 prints the traditional game cashout vouchers. The speakers 224 can be made to produce sounds or music by the bonus engine 220. Although the specific hardware included in the gaming device 10 is important in implementing embodiments of the invention, the invention can operate regardless of the type of components in the gaming device 10.

Although a system printer 222 and game printer 212 have been described, other printer configurations are possible and contemplated within the scope of the invention. For example, in another embodiment, a single printer, having two inputs, one from the game electronics 15 and the second from the bonus engine 220 receives, acts upon, and reconciles printing requests from both devices. In a similar embodiment, a single printer with a single input is routed through a device having two inputs, one for the game electronics 15 and the other for the bonus engine 220. In another embodiment, a single printer is coupled directly to the game electronics 15, with the bonus engine 220 coupled to the game electronics and not directly coupled to the printer. In this configuration, print commands originating from the game electronics are transmitted directly from the game electronics 15 to the printer. Print commands originating from the bonus engine are sent from the bonus engine 220 to the game electronics 15 and are then transmitted to the printer. In this way, the game electronics 15 perform a routing and reconciling function for the shared printer. In yet another embodiment, the bonus engine 220 and game electronics 15 reverse functions from the above example, and the bonus engine assumes the routing and reconciliation functions for the shared printer.

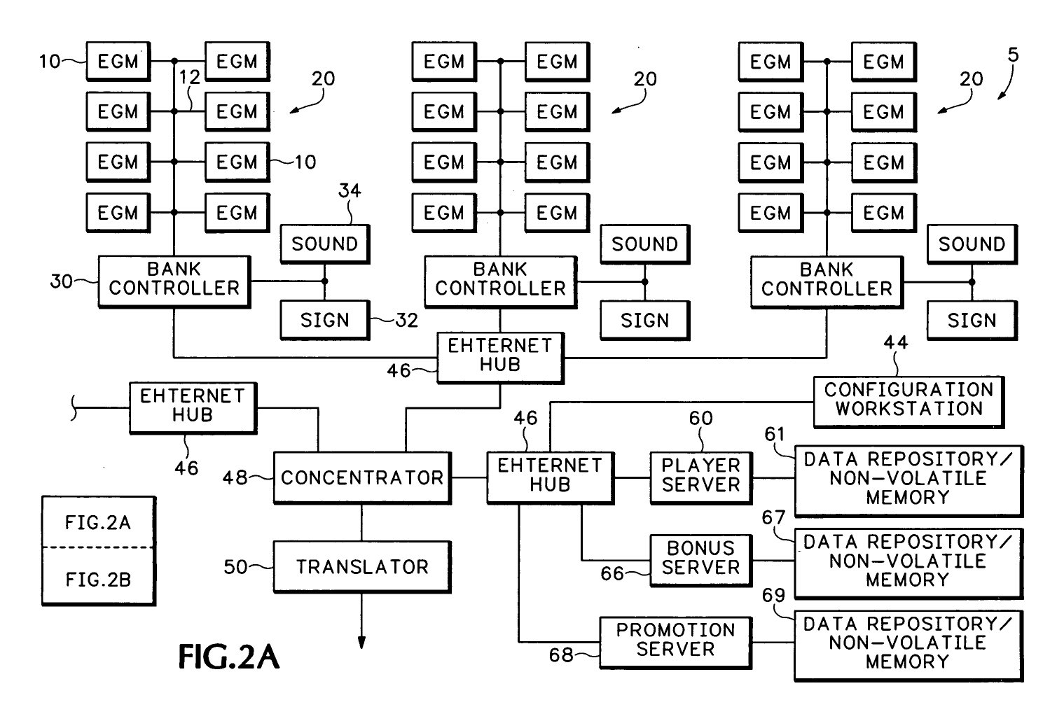

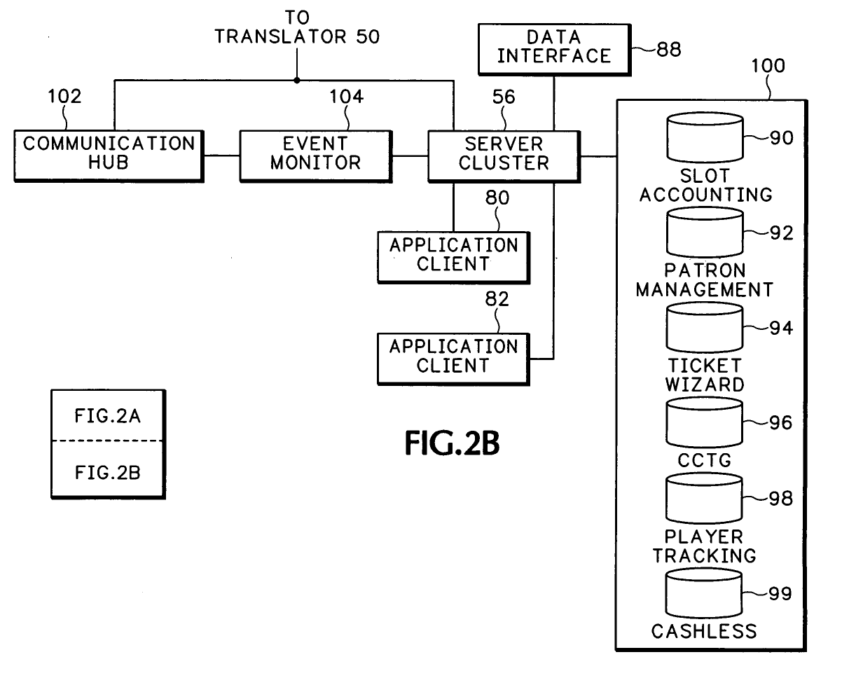

One such gaming network is illustrated in FIGS. 2A and 2B. In a gaming network 5, a number of EGMs 10 are organized in groups called banks. Individual banks 20, 22, and 24, can contain almost any number of EGMs 10. Additionally, any number of banks is possible in a gaming network 5. The gaming network 5 illustrated in FIGS. 2A and 2B is only an example gaming network. Those skilled in the art will appreciate that embodiments of the invention can operate on any acceptable network, even if it differs from the one illustrated.

Each bank is controlled by a bank controller 30, which is coupled to each EGM 10 by a communication cable 12. The bank controller 30 facilitates data communication between the EGMs 10 in its associated bank and the other components on the gaming network 5. In some embodiments, the bank controller 30 need not be present, and the EGMs 10 communicate directly with the other portions of the gaming network 5. The bank controller 30 can include audio capabilities, like an audio board or sound card for transmitting digitized sound effects, such as music and the like, to a sound system 34 coupled to the bank controller. Additionally, the bank controller 30 or sound system 34 may include a device for playing locally stored sounds, such as a hard-drive, CD or DVD-ROM drive. The bank controller 30 can also be connected to an electronic sign or screen 32 that displays information, such as scrolling, flashing, or other types of messages that indicate jackpot amounts and the like, which are visible to players of machines on a particular bank. These message displays 32, 34 may be generated or changed responsive to commands issued over the network 5 to the bank controller 30. The sounds and images created by the bank controller may be identical for each of the banks 20, 22, 24, or all of sounds and images created by the banks may be different than the others.

Configuration data for the gaming network 5 is stored in one or more network data repositories 61, 67, 69. In some embodiments, the data repositories 61, 67, 69 are made of battery backed-up non-volatile SRAM (Static Random Access Memory), which provides dual advantages of having extremely fast data input and output, and having a power source that is independent from the network 5 or the EGMs 10. The data repositories 61, 67, 69 may also be mirrored, i.e., duplicate copies are made in real-time. This prevents data from being lost if one of the battery sources should fail or other catastrophic event. Data may be stored in the data repositories 61, 67 69 using CRCs (Cyclic Redundancy Checks) and timestamps to ensure the data is valid and non-corrupt.

Configuration data is created at a configuration workstation 44 and stored in the data repositories 61, 67, 69. Configuration data may include message data for players as well as for promotions such as bonuses. Player message data is stored in the data repository 61, where it can be accessed by a player server 60. Player message data can include welcoming messages, card-in/card-out messages, and special messages about current promotions, for instance. The player server 60 reads the message data from the data repository 61 and sends a properly formatted message back to the bank controllers 30 and EGMs 10. These player messages may be displayed on a screen 32 for an entire bank, or may be shown on a screen directly mounted to the EGM 10 (not shown).

Other configuration data created at the configuration workstation 44 and stored in the data repositories 61, 67, 69 may include casino configuration data, such as identification of each EGM 10 on a casino floor. Additional parameters stored in the data repository 67, 69 are parameters used in promotions, such as bonus promotions. These parameters include such items as what EGMs 10 are included in the promotion, how to fund a bonus, i.e., if a bonus is funded by a portion of the coin-in amount of the EGMs 10, whether a paid bonus is to be taxed or non-taxed, and other parameters.

As players play the EGMs 10 in the gaming network 5, the EGMs send data from their coin meters, or meter values. One or more bonus server 66 stores these meter values, or summaries of the meter values, in its associated data repository 67.

The bonus servers 66 can also operate based on the present and stored meter values to determine an amount of money being wagered on the EGMs in near real-time. The bonus servers 66 can use the amount of money being wagered to calculate bonus pools that are funded as a percentage of the coin-in of participating EGMs 10. For instance, the bonus servers 66 can calculate a present amount of a bonus pool that is funded at one-half of one percent of the coin-in for the participating EGMs 10. An example of bonus promotions that can be operated from the bonus servers 66 includes LUCKY COIN and progressive bonuses, for example.

The promotion server 68, like the bonus server 66, can use an amount of money being wagered to calculate promotion pools funded as a percentage of the coin-in. Alternatively, the casino or operator can configure the promotion server 68 to award promotions not related to coin-in, for example, incentives for enrolling in player tracking programs. The promotion server 68 may include functions and processes operative to generate signals to cause a system award to be generated, and to communicate the generated system award to the particular EGM 10 at which the player receiving the award can receive the award.

In determining when to grant a bonus or system award, the promotion server 68 can access data stored anywhere on the network 5 looking for triggering events, such as: from any of the databases 100 described below; from any of the data repositories 61, 67, 69; from the bank controller 30; and from a bonus engine 220 (FIG. 1) on any or all of the EGMs 10 coupled to the gaming network.

When the promotion server 68 determines that a triggering event has been satisfied and that a system or bonus award should be generated, it sends appropriate signals to the bonus engine 220 of the appropriate EGM 10 through the gaming network 5 to deliver the award. Records of awards and bonuses may be maintained by the promotion server 68 or elsewhere in the gaming network 5 for tracking and accounting purposes.

Of course, the servers 60, 66, 68 could be embodied in a single device, or in other configurations, and do not have to appear as in FIG. 2A, which is only a functional representation. Likewise, the data repositories 61, 67, 69 could be embodied in a single device.

As data is generated by the EGMs 10, data is passed through communication hardware, such as Ethernet hubs 46, and a concentrator 48. Of course, switches or bridges could also be used. The concentrator 48 is also coupled to a translator 50, which includes a compatibility buffer so that the data from the EGMs 10 can be used by a server cluster 56 (FIG. 2B), and other parts of the gaming network 5. A communication hub 102, in turn, is connected to the translator 50 and to an event monitor 104. The event monitor 104 is also coupled to a server cluster 56 (FIG. 2B). The server cluster 56 may, of course, be embodied by more than one physical server box. In practice, including multiple server boxes with dynamic load sharing and backup capabilities of one another ensures the gaming network 5 is nearly always operational.

The server cluster 56 is attached to and manages several databases, such as a slot accounting database 90, a patron management database 92, a ticket wizard database 94, a “Cage Credit and Table Games” (CCTG) database 96, a player tracking database 98, and a cashless database 99. These databases are collectively referred to as the databases 100. Of course these databases 100 are only exemplary, and more or fewer databases can be part of the gaming network 5. In some embodiments, particular servers in the server cluster 56 manage a single database. For example, a single server in the server cluster 56 may manage the slot accounting database 90, while another server manages the patron management database 92. Such implementation details are well within the expertise of one skilled in the art. However, for ease of illustration, FIG. 2B shows a single server cluster 56 that is coupled to all of the databases 100.

In operation, the slot accounting database 90 receives and stores statistical and financial information about the EGMs, such as dates, times, totals, game outcomes, etc. The patron management database 92 stores information regarding identified players, such as how often and which games they play, how often they stay in the casino, their total loyalty points, past awards, preferences, etc. The ticket wizard database 94 stores data about tickets that are issued by the EGMs, such as payouts and cashout tickets, as well as promotional tickets.

The CCTG database 96 stores information about non-EGM 10 data in a casino. That data is typically generated by a client station (not shown) coupled to one of the bank controllers 30. The client station can be located in a casino cage or at a table game, for instance, and data generated by the client station is forwarded to the CCTG database 96 where it is stored. For example, data such as when and how many chips a customer buys, when a customer creates or pays off markers, when a customer cashes checks, etc. is stored in the CCTG database 96.

The player tracking database 98 is a subset database of the patron management database 92, and is used when data retrieval speed is important, such as for real time promotions and bonusing. The cashless database 99 stores information about payment options other than bills, coins, and tokens.

Application clients 80 and 82 couple to the server cluster 56, and can retrieve data from any or all of the databases 100. Application programs run on an application client 80, 82 to provide users information about the gaming network 5 and the casino in which the network is established and to cause functions to operate on the gaming network 5. An example application client 80 could include, for instance, an accounting server that allows queries and provides reports on financial and statistical information on single or groups of EGMs 10.

A data interface 88 presents a uniform interface to other applications and servers (not shown), and grants access to retrieve data from the databases 100. Typically these other clients or servers would not be controlled by the same entity that provides the other components of the gaming network 5, and therefore the data interface 88 grants only guarded access to the databases 100.

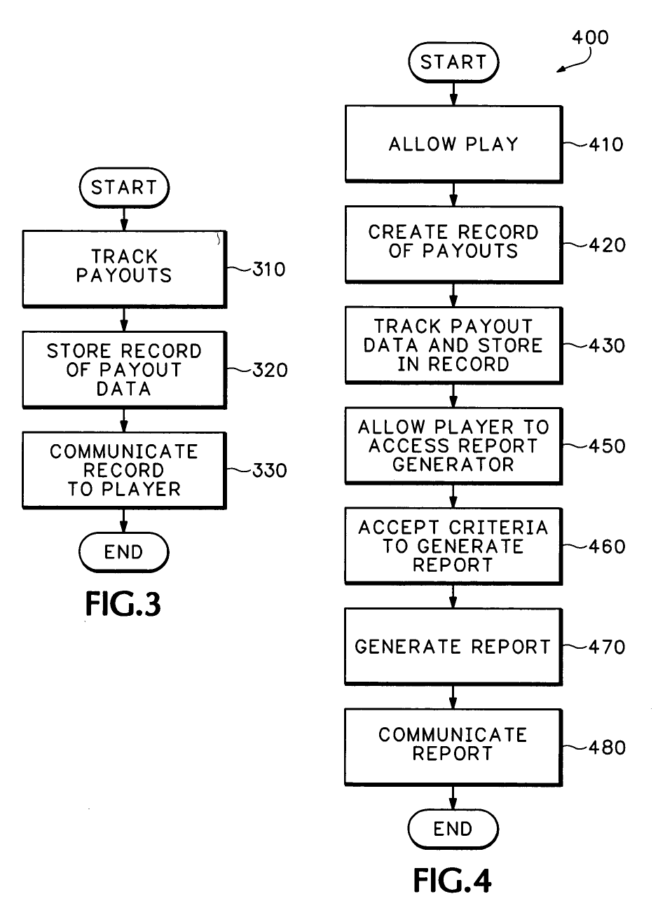

Details of how the gaming network of FIGS. 2A and 2B tracks payout events, stores records of payout events and communicates payout records to players are shown in FIGS. 3 and 4. FIGS. 3 and 4 are example flow diagrams illustrating processes that can be used by the system. For brevity, functions relating to payout events and communicating payout records will be referred to as occurring on the promotion server 68, although they could be performed on the player server 60, bonus server 66, bonus engine 220, or elsewhere in the gaming network 5.

In FIG. 3, a flow 300 begins at process 310 where payout events are tracked. As previously discussed, payout events can refer to any data associated with player wins and losses, for example, actual amounts paid out, dates amounts were paid out, payouts relative to other machines, frequency of payout, etc. In some embodiments, payout data is tracked for a particular machine and is therefore not player specific. Other embodiments can tie such data to player accounts stored in the patron management database 92 in FIG. 2B. In computing payout events relative to other machines, the EGM 10 is coupled to the network 5. However, to track payout events for a given machine it is not necessary in all embodiments that the gaming devices are networked together. Payout data is tracked for each player using a particular EGM 10. The type of data tracked can include, for example: the dates and times the gaming device is played, the amount of coin in, the amount of payout, the number of games played, the number of play sessions, the dates and times of payout, the types of payout, etc.

At a process 320 the promotion server 68 stores a record of the tracked payouts. The record can include any data tracked by the promotion server 68. For example, the record can include times and dates of wins or losses, the number of player sessions played on a particular gaming device, the elapsed time between payout events, etc. The record is accessible for generating reports configured by the user or player. Reports will be described in greater detail below.

At a process 330 the record is communicated to the player in the form of a report. The report can be of standard form or can be customized by the player. For example, the casino might simply want to identify machines that are hot or cold, based on preset criterion established by the casino. An example of a hot machine might include those machines whose payback percentage over some unit of time is greater than the typical payback percentage of the given machine. Other examples could include machines paying out particularly large awards or jackpots, or machines having a certain frequency of particular hand types, such as four-of-a-kind, in a given period. Machines paying out below the typical payback for a unit of time might be cold machines. Other cold machines could include those machines that have not hit a jackpot in a given period of time or machines that have not experienced the given frequency of particular hand types. The system could identify hot and cold machines by color coded lights, or other types of animation or graphics, associated with each gaming device. Using this example, a hot machine could display a red light while a cold machine displayed a blue light. Machines falling in the spectrum between hot and cold could be associated with different colors with the casino providing a legend for players to identify what particular colors in the spectrum represent. The color codes of each machine can likewise be communicated to the player using a touchscreen display associated with the EGM 10 or a bank of gaming devices 20. Alternatively, the color codes can be communicated through interactive maps available for viewing on the internet or through other electronic means either before or after the player enters the casino or game floor, at a stand alone terminal like a kiosk, or a customer service desk.

The report can also be a communication to the player through the display 218 or printer 212 associated with the EGM 10 or bank of gaming devices 20 (FIG. 2A). Such displays or printers can also be provided at an unattended kiosk or staffed customer service desk. The report can also be communicated via speakers or a sound system associated with an individual EGM 10, bank of gaming devices 20, kiosk or customer service desk. The report can communicate as much information as desired by the casino. For example an audio report could be simply that a given machine is hot or cold, or can provide additional historical data such as that discussed previously. Additional examples of how the report can be communicated to one or more players are through the use of an overhead sign, through public address, through vouchers, mailings, handouts, electronic devices, or personal digital assistants.

A casino can also designate the players to whom reports will be made available. For example, a casino might want to limit the information to players who belong to a player tracking system or players having high player ratings based on criteria established by the casino. The casino could make the reports available to these particular players through access controlled internet or electronic means, or by making the information available on a display associated with the EGM 10 after the player enters a personal identification number (PIN), uses a player tracking card, or otherwise makes his/her presence known to casino personnel or the network 5.

FIG. 4 is another example of a flow diagram illustrating processes that can be used by the promotion server 68 to generate historical payout data in the form of records or reports.

A flow 400 begins at process 410 when an EGM 10, which can, although need not, be coupled to the gaming network 5, allows play at a process 420. The promotion server 68 creates a record of payouts at a process 430. The promotion server, at a process 440, begins tracking play on the particular gaming device and stores the tracked play in the record corresponding to the particular gaming device. The order of play, creating a record and tracking payout data is irrelevant. One order has been chosen and demonstrated for purposes of FIG. 4 although other orders are contemplated and within the scope of the invention.

At a decision 450 one or more players is given access to a report generator for purposes of generating a report of gaming device past payout data. The report generator can be associated with a gaming device or remote from the device. The report generator can be made available on the internet or through other electronic means, or can be available at an unmanned kiosk or an attended customer service desk. The report generator can identify a particular device or a group of devices for which reports can be generated. For example, a player might be shown a map of all gaming devices located in a particular casino and be permitted to touch an icon representing a particular gaming device to get information pertaining to that gaming device. Alternatively, a player might simply select all hot or all cold gaming devices and be provided with a map showing the locations of the various gaming devices by their associated color codes.

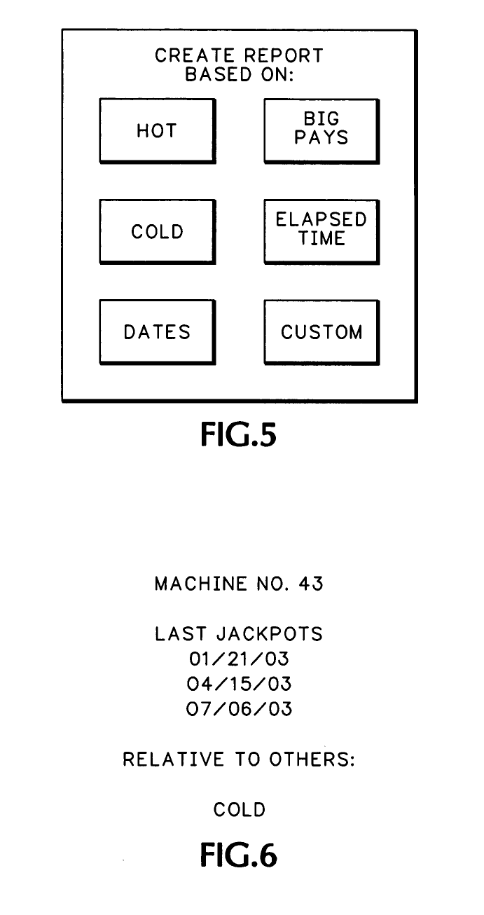

At decision 460 the player or players can input criteria to be accepted by the system for the purpose of generating a report. For example, the player might select an option corresponding to a standard report, such as all hot or all cold gaming devices as described above. Input criteria for a sample standard report is shown in FIG. 5. In FIG. 5 the player can use a touchscreen to identify the standard report to be generated. The options can be made known to the player through displays at any of the locations described above. Other standard reports might take into consideration the date and time of, for example, the last 5 or 10 payouts to compute an elapsed time between payouts, or reports showing the 5 gaming devices with the highest level of payout relative to other devices. Standard reports can be configured by the user or casino based on predetermined criteria. Also shown in FIG. 5 is an option allowing the player to select a custom report. Players can customize reports by selecting data to be included in the report. The data for inclusion in the report can include any data contained in the record or data that can be manipulated from data contained in the record. A sample customized report for an individual gaming device is shown in FIG. 6. In FIG. 6, information is provided with respect to the individual EGM (last jackpots), as well as how the machine compares relative to other machines (cold). The possible information provided in a custom report is limited only by the criterion established by the user or casino in establishing the data to be tracked and manipulated.

Turning again to FIG. 4, after the promotion server 68 has accepted the criteria to generate the report, the report is generated at a process 470 and then communicated to the player at a process 480 in one of the forms previously discussed.

Using the system described with reference to FIGS. 2A and 2B and further described above in FIGS. 3 through 6, casinos can communicate historical payout data for particular gaming devices to one or more players to aid players in selecting gaming devices for play.

Thus, although particular embodiments for hot machine notification have been discussed, it is not intended that such specific references be considered as limitations upon the scope of this invention, but rather the scope is determined by the following claims and their equivalents.

1. A method for communicating a gaming machine's past payouts to a player, comprising:
tracking gaming machine payout data;
storing a record of the payout data in memory accessible by the gaming machine; and
communicating to the player a report derived from the record.

2. The method of claim 1, in which tracking gaming machine payout data comprises tracking winning events.

3. The method of claim 1, in which tracking gaming machine payout data comprises tracking the frequency of winning events in a selected time period.

4. The method of claim 1, in which tracking gaming machine payout data comprises tracking particular hand types.

5. The method of claim 1, in which tracking gaming machine payout data further comprises:
tracking the gaming machine's typical payout data;
selecting a time period; and
comparing the gaming machine's typical payout data to the machine's payout data for the selected time period.

6. The method of claim 1, in which communicating to the player a report comprises communicating a visual report.

7. The method of claim 6, in which the visual report is communicated through a display associated with the gaming machine.

8. The method of claim 6, in which the visual report is communicated through a terminal remote from the gaming machine.

9. The method of claim 1, in which the visual report is printed.

10. The method of claim 9, in which the visual report is printed at the gaming machine.

11. The method of claim 9, in which the report is printed remote from the gaming machine.

12. The method of claim 1, in which communicating to the player a report comprises communicating an aural report.

13. The method of claim 12, in which the aural report is communicated through a speaker associated with the gaming machine.

14. The method of claim 12, in which the aural report is communicated through a speaker remote from the gaming machine.

15. The method of claim 1, in which communicating to the player a report comprises communicating to the player a standard report.

16. The method of claim 1, in which communicating to the player a report comprises communicating to the player a custom report.

17. The method of claim 1, in which communicating to the player a report comprises communicating the report to the player before the player enters a game floor.

18. The method of claim 17, in which the report is communicated to the player through electronic means.

19. The method of claim 1, in which communicating to the player a report further comprises communicating the report to a plurality of players.

20. The method of claim 19, in which the report is communicated to a subset of the plurality of players.

21. The method of claim 20, in which the subset of the plurality of players are enrolled in a player tracking system.

22. The method of claim 20, in which the subset of the plurality of players are players with high player value ratings.

23. The method of claim 1, in which the report comprises a color code corresponding to the payout data.

24. The method of claim 23, in which the color code is associated with the gaming machine.

25. The method of claim 24, in which the color code is associated with a plurality of gaming machines

26. The method of claim 25, in which the plurality of gaming machines are sortable by color code.

27. The method of claim 26, further comprising printing a map of the plurality of gaming machines.

28. The method of claim 1, in which the record comprises data corresponding to a selected time period.

29. The method of claim 28, in which the selected time period is an elapsed time between specific payouts.

30. The method of claim 28, in which the selected time period is configured by a user.

31. The method of claim 1, in which the record comprises data corresponding to a number of plays between winning events.

32. The method of claim 1, in which the record comprises data corresponding to particular outcomes.

33. The method of claim 1, in which the record comprises data derived from a plurality of gaming machines.

34. The method of claim 33, in which the record is sortable by the frequency of winning events.

35. A method for generating a report of a gaming machine's past payouts, comprising:
creating a record of payout data;
tracking payout data;
storing tracked payout data in the record;
allowing a player to access a report generator;
accepting criteria to generate a report derived from the payout data;
generating the report; and
communicating the report to the player.

36. The method of claim 35, in which communicating the report to the player comprises communicating a standard report to the player.

37. The method of claim 35, in which communicating the report to the player comprises communicating a custom report to the player.

38. A system for displaying a gaming machine's historical payout data, comprising:
a gaming machine;
memory for storing a record of machine payouts; and
a report generator coupled to the memory and configured to communicate payout data to a player.

39. The system of claim 38, further comprising a plurality of gaming machines and a network interconnecting the plurality of gaming machines.

40. The system of claim 38, further comprising a display.

41. A system for displaying the past payout data of a gaming machine, comprising:
a plurality of gaming machines, each gaming machine having a display;
a server coupled to the plurality of gaming machines;
past play data stored on the server; and
a processor structured to analyze the past play data and to generate indicia on the display, the indicia corresponding to the past play data.
